(19) United States
(12) Patent Application Publication
(10) Pub. No.: US 2026/0086924 A1
(43) Pub. Date: Mar. 26, 2026

(54) AN OPTIMAL TEST CASE SELECTION METHOD BASED ON TEST CASE MULTI-DIMENSIONAL CORRELATION DEGREE

(71) Applicant: Dell Products L.P., Round Rock, TX (US)

(72) Inventors: Jessica Ye, Chengdu (CN); Michael Chen, Chengdu (CN); Kiko Wang, Chengdu (CN)

(73) Assignee: Dell Products L.P., Round Rock, TX (US)

(21) Appl. No.: 18/916,892

(22) Filed: Oct. 16, 2024

(30) Foreign Application Priority Data
Sep. 26, 2024 (CN) 202411357496.8

(51) Int. Cl. G06F 11/36

(52) U.S. Cl. CPC G06F 11/3676; G06F 11/3688; G06F 11/3692

(57) ABSTRACT

Methods, system, and non-transitory processor-readable storage medium for test correlation selection system are provided herein. An example method includes executing a plurality of test cases on a system. The test correlation selection system analyzes a correlation among the executed test cases by examining a result of the execution of the plurality of test cases to create a test case set correlation degree matrix. The test correlation selection system selects a subset of the plurality of test cases, based on the test case set correlation degree matrix, to execute on a test system to optimize test coverage of the plurality of test cases.

### FIELD

The field relates generally to optimizing test coverage, and more particularly to optimizing test coverage in information processing systems.

### BACKGROUND

Customers demand high quality software. Software testing controls the product quality during the software development process, and adequate test coverage is one component of the product quality. The design quality of test cases, the selection, and maintenance of the test cases all affect the quality of the software testing.

### SUMMARY

Illustrative embodiments provide techniques for implementing a test correlation selection system in a storage system. For example, illustrative embodiments execute a plurality of test cases on a system. The test correlation selection system analyzes a correlation among the executed test cases by examining a result of the execution of the plurality of test cases to create a test case set correlation degree matrix. The test correlation selection system selects a subset of the plurality of test cases, based on the test case set correlation degree matrix, to execute on a test system to optimize test coverage of the plurality of test cases. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a test correlation selection system in an illustrative embodiment.

FIG. 2 shows a flow diagram of a process for a test correlation selection system in an illustrative embodiment.

FIG. 3 illustrates a multi-dimensional correlation of test cases based on test case failure pools in an illustrative embodiment.

FIG. 4 illustrates the relationship between the module unique failure list and the test case unique failure list in an illustrative embodiment.

FIGS. 5 and 6 show examples of processing platforms that may be utilized to implement at least a portion of a test correlation selection system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a test correlation selection system, which technique may be used to provide, among other things, test coverage optimization by executing a plurality of test cases on a system. The test correlation selection system analyzes a correlation among the executed test cases by examining a result of the execution of the plurality of test cases to create a test case set correlation degree matrix. The test correlation selection system selects a subset of the plurality of test cases, based on the test case set correlation degree matrix, to execute on a test system to optimize test coverage of the plurality of test cases.

The productivity of software development processes is constantly rising as customers demand higher and higher quality. Optimizing the test coverage of test software (i.e., test cases) is critical to the success of software projects. The failures that result when test cases are executed reveal the actual testing points of those test cases. Multiple test cases may have the same test points. The more test points there are in common between, for example, two test cases, the greater the correlation between the two test cases. Identifying the correlation between test cases allows for greater optimization of test coverage by selecting a group of test cases that have the least correlation among the selected test cases.

Conventional technologies for optimizing test coverage rely on software testers to select which test cases will be used to test a product, based on the software testers' experience, making it difficult to ensure the test quality and test efficiency. Conventional technologies lack efficiency and accuracy. Conventional technologies fail to provide a standard quantitative test case selection algorithm. Conventional technologies fail to provide a multi-dimensional failure-based algorithm for expressing the correlation between test cases. Conventional technologies fail to express the correlation between test cases in different dimensions such as a module layer, test case layer, and test case set layer, using the failure that occur when the test cases are executed.

By contrast, in at least some implementations in accordance with the current technique as described herein, test coverage is optimized by executing a plurality of test cases on a system. The test correlation selection system analyzes a correlation among the executed test cases by examining a result of the execution of the plurality of test cases to create a test case set correlation degree matrix. The test correlation selection system selects a subset of the plurality of test cases, based on the test case set correlation degree matrix, to execute on a test system to optimize test coverage of the plurality of test cases.

Thus, a goal of the current technique is to provide a method and a system for providing a test correlation selection system that can optimize the selection of test cases executed on test systems to efficiently optimize the test coverage of those test systems. Another goal is to provide an efficient, accurate, comprehensive, objective system for optimizing test coverage regardless of the types of tests, the purpose of the test, and/or the number of tests running on a test system. Another goal is to provide a standard quantitative test case selection algorithm. Another goal is to provide a multi-dimensional failure-based algorithm for expressing the correlation between test cases. Yet another goal is to express the correlation between test cases in different dimensions such as a module layer, test case layer, and test case set layer, using the failures that occur when the test cases are executed.

In at least some implementations in accordance with the current technique described herein, the use of a test correlation selection system can provide one or more of the following advantages: providing a standard quantitative test case selection algorithm, providing a multi-dimensional failure-based algorithm for expressing the correlation between test cases, and providing an algorithm that expresses the correlation between test cases in different dimensions such as a module layer, test case layer, and test case set layer, using the failures that occur when the test cases are executed.

In contrast to conventional technologies, in at least some implementations in accordance with the current technique as described herein, test coverage is optimized by executing a plurality of test cases on a system. The test correlation selection system analyzes a correlation among the executed test cases by examining a result of the execution of the plurality of test cases to create a test case set correlation degree matrix. The test correlation selection system selects a subset of the plurality of test cases, based on the test case set correlation degree matrix, to execute on a test system to optimize test coverage of the plurality of test cases.

In an example embodiment of the current technique, the result comprises failures that occurred during the execution of the plurality of test cases on the system.

In an example embodiment of the current technique, the test correlation selection system creates a test case unique failure list from the result, where the test case unique failure list comprises unique failure identifiers associated with a test case, and where the plurality of test cases comprises the test case.

In an example embodiment of the current technique, the test correlation selection system creates a module unique failure list from the result, where the module unique failure list comprises unique failure identifiers associated with a test module associated with a test case, and where a test case comprises one or more test modules.

In an example embodiment of the current technique, the test correlation selection system creates a test case unique failure list comprising a plurality of unique module unique failure lists associated with a plurality of modules associated with a test case.

In an example embodiment of the current technique, the test correlation selection system identifies a plurality of failure identifiers associated with the result of the execution of the plurality of test cases, where each test case failure that occurs during the execution of the plurality of test cases on the test system is associated with a respective failure identifier of the plurality of failure identifiers.

In an example embodiment of the current technique, for each failure identifier, the test correlation selection system determines that the failure identifier does not have an associated parent failure identifier and associates the failure identifier with the module unique failure list.

In an example embodiment of the current technique, for each failure identifier, the test correlation selection system determines that the failure identifier has an associated parent failure identifier, determines that the associated parent failure identifier is not associated with the module unique failure list, and associates the associated parent failure identifier with the module unique failure list.

In an example embodiment of the current technique, the test correlation selection system determines a test module correlation degree between at least two test cases associated with a test module, using a module unique failure list.

In an example embodiment of the current technique, the test correlation selection system represents the test module correlation degree between at least two test cases for a plurality of test modules, in a matrix format, where the plurality of test modules comprises the test module.

In an example embodiment of the current technique, the test correlation selection system represents the test module correlation degree for a plurality of test cases associated with the plurality of test modules as a test module correlation degree matrix, where the test module correlation degree matrix indicates a correlation between at least two test cases at a module level.

In an example embodiment of the current technique, the test correlation selection system determines a test case correlation degree between at least two test cases, where the test case correlation degree is an average of a plurality of test module correlation degrees for at least two test cases.

In an example embodiment of the current technique, the test correlation selection system determines a test case plurality correlation degree, where the test case plurality correlation degree is a correlation degree of a test case in the plurality of test cases against the other test cases in the plurality of test cases.

In an example embodiment of the current technique, the test correlation selection system determines a test case set correlation degree, where the test case set correlation degree is a sum of test case plurality correlation degrees associated with a test case set, and where the test case set comprises the plurality of test cases.

In an example embodiment of the current technique, the test correlation selection system determines a minimum sum of matrix elements associated with a column of a test case set correlation degree matrix, and selects a test case associated with the column for inclusion in the subset of the plurality of test cases.

In an example embodiment of the current technique, the test correlation selection system replaces the column with zeros in the test case set correlation degree matrix, and replaces a row associated with the selected test case with zeros in the test case set correlation degree matrix.

In an example embodiment of the current technique, the test correlation selection system repeats the steps of determining the minimum sum of matrix elements and selecting the test case after replacing the column with zeros in the test case set correlation degree matrix.

In an example embodiment of the current technique, the test correlation selection system determines there are at least two columns associated with the minimum sum, and randomly selects one of the columns for inclusion in the subset of the plurality of test cases.

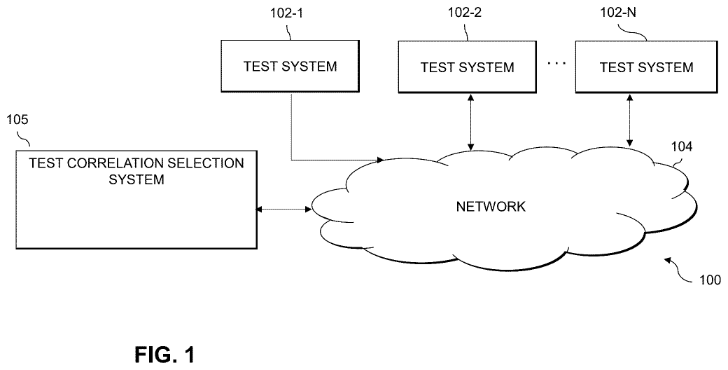

FIG. 1 shows a computer network (also referred to herein as an information processing system) 100 configured in accordance with an illustrative embodiment. The computer network 100 comprises test systems 102-N. The test systems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a test correlation selection system 105 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the test systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The test systems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the test correlation selection system 105 are one or more input-output devices, which illustratively comprise keyboards, displays or other types of input-output devices in any combination. Such input-output devices can be used, for example, to support one or more user interfaces to the test correlation selection system 105, as well as to support communication between the test correlation selection system 105 and other related systems and devices not explicitly shown. For example, a dashboard may be provided for a user to view a progression of the execution of the test correlation selection system 105. One or more input-output devices may also be associated with any of the test systems 102-N.

Additionally, the test correlation selection system 105 in the FIG. 1 embodiment is assumed to be implemented using at least one processing device. Each such processing device generally comprises at least one processor and an associated memory, and implements one or more functional modules for controlling certain features of the test correlation selection system 105.

More particularly, the test correlation selection system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the test correlation selection system 105 to communicate over the network 104 with the test systems 102-N and illustratively comprises one or more conventional transceivers.

A test correlation selection system 105 may be implemented at least in part in the form of software that is stored in memory and executed by a processor, and may reside in any processing device. The test correlation selection system 105 may be a standalone plugin that may be included within a processing device.

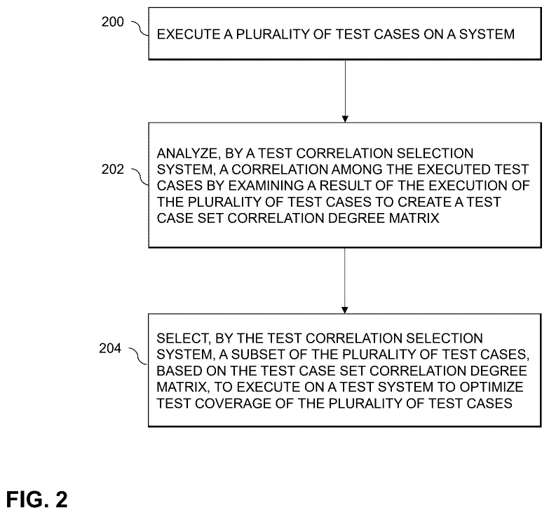

It is to be understood that the particular set of elements shown in FIG. 1 for test correlation selection system 105 involving the test systems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the test correlation selection system 105 can be on and/or part of the same processing platform. An exemplary process of test correlation selection system 105 in computer network 100 will be described in more detail with reference to, for example, the flow diagram of FIG. 2.

FIG. 2 is a flow diagram of a process for execution of the test correlation selection system 105 in an illustrative embodiment. It is to be understood that this particular process is only an example, and additional or alternative processes can be carried out in other embodiments.

At 200, a plurality of test cases is executed on a system or a test system 102-N. A test case may be executed on several different test systems 102-N, and/or several test cases may be executed on a single test system 102-1.

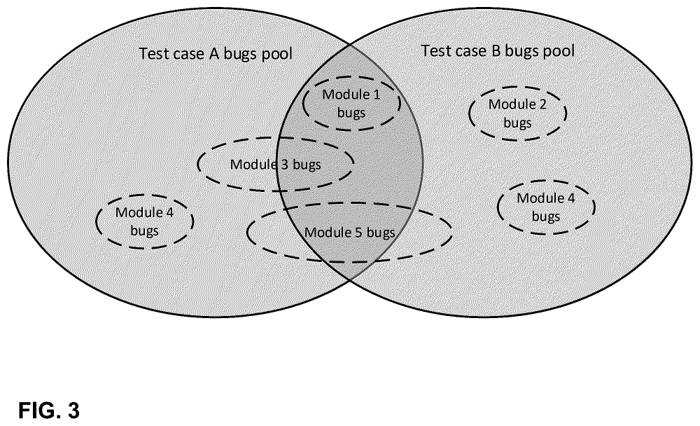

At 202, a test correlation selection system 105 analyzes a correlation among the executed test cases by examining a result of the execution of the plurality of test cases to create a test case set correlation degree matrix. In an example embodiment, the result comprises failures that occurred during the execution of the plurality of test cases on the system. In an example embodiment, the failures are tracked at multiple levels, according to an area, feature and/or module of the product in the failure system. The hierarchical relationship of how the failures are tracks maps to the hierarchical relationships of the products being tested by the test cases. FIG. 3 illustrates a multi-dimensional correlation of test cases based on test case failure (i.e., “bugs”) pools. The failure/bug area of each of test case A and test case B is comprised of multiple test module failure areas. The intersection of the circles representing test case A and test case B represents the same failures found in both test case A and test case B. The larger the area of the intersection, the greater the number of identical failures/bugs found by test case A and test case B, meaning the greater the correlation between test case A and test case B.

In an example embodiment, when there are multiple test failures that identify the same system problem, these test failures are duplicated to a parent failure identifier. The parent failure identifier may also be referred to as a unique failure identifier. In an example embodiment, based on the hierarchical relationship between test cases and test modules, two levels of failure lists are defined; module unique failure list and test case unique failure list.

In an example embodiment, the test correlation selection system 105 creates a module unique failure list from the test execution result. The module unique failure list comprises unique failure identifiers associated with a test module associated with a test case, where the test case comprises one or more test modules. In other words, the module unique failure list comprises all the unique failure identifiers raised by a test case, where the failures occur when a module is executing.

In an example embodiment, the test correlation selection system 105 creates a test case unique failure list from the result, where the test case unique failure list comprises unique failure identifiers associated with a test case, and where the plurality of test cases comprises the test case. In an example embodiment, the test correlation selection system 105 identifies a plurality of failure identifiers associated with the result of the execution of the plurality of test cases. Each test case failure that occurs during the execution of the plurality of test cases on the test system is associated with a respective failure identifier of the plurality of failure identifiers.

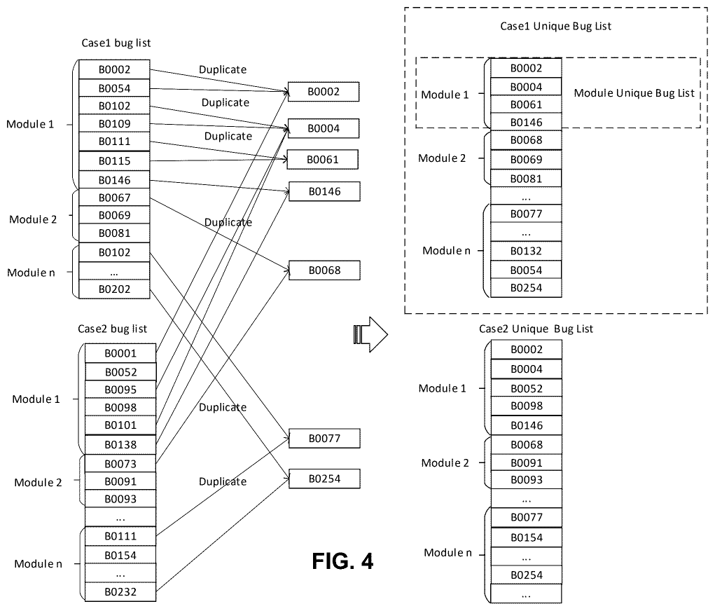

In an example embodiment, the test correlation selection system 105 creates a test case unique failure list comprising a plurality of unique module unique failure lists associated with a plurality of modules associated with a test case. In other words, the test case unique failure list comprises all the unique failure identifiers for a test case. It is a collection of all the module unique failure lists associated with a particular test case. FIG. 4 illustrates the relationship between the module unique failure list (indicated as “Module Unique Bug List”) and the test case unique failure list (indicated as “Case1 Unique Bug list” and “Case2 Unique Bug List”).

In an example embodiment, the test correlation selection system 105 sorts the unique failure identifiers associated with a test case, and then examines the first unique failure identifier in the list. In an example embodiment, for each failure identifier, the test correlation selection system 105 determines whether the failure identifier has an associated parent failure identifier. If the failure identifier does not have an associated parent failure identifier, the test correlation selection system 105 associates the failure identifier with the module unique failure list. If the failure identifier has an associated parent failure identifier, the test correlation selection system 105 determines whether the associated parent failure identifier is associated with a module unique failure list. If the test correlation selection system 105 determines that the associated parent failure identifier is not associated with the module unique failure list, the test correlation selection system 105 inserts the associated parent failure identifier into the module unique failure list. If the test correlation selection system 105 determines that associated parent failure identifier already exists in the module unique failure list, then the test correlation selection system 105 obtains the next failure identifier from the sorted list, and repeats the process. The test correlation selection system 105 examines each failure identifier in the sorted list in this manner.

In an example embodiment, the test correlation selection system 105 determines a test module correlation degree between at least two test cases associated with a test module, using a module unique failure list. The test module correlation degree between two or more test cases at the same test point is the correlation of the test cases. For a given test case, the failures, or “bugs” are distributed in different test product areas, and each test area is divided into multiple different test modules. In an example embodiment, the test module is the smallest statistical unit in the failure/bug system.

In an example embodiment, the test module correlation degree is the correlation degree of at least two test cases associated with one test module. In effect, the higher the correlation degree, the greater the correlation between two test cases associated with the same module. The correlation degree may be represented as illustrated below, where M_{case i} is the unique failure list of a module in case i.

$${β}_{M ( Case i , Case j )} = \frac{\vert {M}_{case i} ⋂ {M}_{case j} \vert}{\vert {M}_{case i} ⋃ {M}_{case j} \vert}$$

Using FIG. 4 as an example, for module 1, test case 1 has 4 unique failure/bug items, and test case 2 has 5 unique failure/bug items.

$${M}_{case 1} = \{ B 0002 , B 0004 , B 0061 , B 0146 \} ,$$

$${M}_{case 2} = \{ B 0002 , B 0004 , B 0052 , B 0098 , B 0146 \} ,$$

$${M}_{case 1} ⋂ {M}_{case 2} = \{ B 0002 , B 0004 , B 0146 \} ,$$

$${M}_{case 1} ⋃ {M}_{case 2} = \{ B 0002 , B 0004 , B 0052 , B 0061 , B 0098 , B 0146 \} .$$

$$So , \vert {M}_{case 1} ⋂ {M}_{case 2} \vert = 4 , \vert {M}_{case 1} ⋃ {M}_{case 2} \vert = 6 ,$$

The Test Module Correlation Degree of case 1 and case 2 is β_{M(Case 1,Case 2)}=0.667

For M test modules, the test module correlation degree of case I and case j may be represented as a 1×M matrix as illustrated below:

$$[ \begin{matrix}{β}_{{M}_{0}} & … & {β}_{{M}_{k}} & … & {β}_{{M}_{M - 1}} ]\end{matrix}$$

In an example embodiment, the test correlation selection system 105 represents the test module correlation degree between at least two test cases for a plurality of test modules, in a matrix format, where the plurality of test modules comprises the test module. In an example embodiment, the test correlation selection system 105 represents the test module correlation degree for a plurality of test cases associated with the plurality of test modules as a test module correlation degree matrix, where the test module correlation degree matrix indicates a correlation between at least two test cases at a module level. For N test cases and M test modules, the test module correlation degree of one test case with respect to the other N−1 test cases may be represented as a (N−1)×M matrix as illustrated below:

$$[ \begin{matrix}{β}_{{M}_{0} ( Case 0 , Case 1 )} & … & {β}_{{M}_{M - 1} ( Case 0 , Case 1 )} \\ ⋮ & ⋱ & ⋮ \\ {β}_{{M}_{0} ( Case 0 , Case N - 1 )} & … & {β}_{{M}_{M - 1} ( Case 0 , Case N - 1 )}\end{matrix} ]$$

In an example embodiment, the test correlation selection system 105 determines a test case correlation degree between at least two test cases, where the test case correlation degree is an average of a plurality of test module correlation degrees for at least two test cases. In other words, the test case correlation degree is the average of all the test module correlation degree values for two test cases, where β_{Case i,Case j}=1 when i=j. The higher the correlation value, the greater the correlation between two test cases. Typically, β_{Case i, Case j}≤1. And β_{(Case i,Case j)}=β_{(Case j,Case i)}. The test case correlation degree is represented as

$${β}_{( Case i , Case j )} = \frac{1}{M} {\sum }_{k = 0}^{M - 1} {β}_{{M}_{k} ( Case i , Case j )}$$

M: The number of modules in the test case

The test case correlation degree reflects the correlation of two test cases, and may be used to evaluate the degree of correlation between the two test cases. For example, if two test cases are selected and the test case correlation degree is close to 1, this indicates the two test cases are highly related, and therefore, the test coverage of these two test cases is highly repetitive. If a tester wishes to have wider test coverage, then only 1 of the two test cases should be selected, and a different second test case should be selected, preferably one that has less correlation with either of the two test cases.

In an example embodiment, the test correlation selection system 105 determines a test case plurality correlation degree, where the test case plurality correlation degree is a correlation degree of a test case in the plurality of test cases against the other test cases in the plurality of test cases. The test case plurality correlation degree is the correlation degree of a test case against other test cases in the plurality of test cases. The higher the value of the test case plurality correlation degree, the greater the correlation between a test case and all the other test cases in the plurality of test cases. The test case plurality correlation degree is represented as:

$${β}_{Case i} = {\sum }_{j = 0}^{N - 1} {β}_{( Case i , Case j )}$$

Where N=The total number of test cases in the plurality of test cases

For a plurality of test cases of N test cases, the correlation degrees of a test case i against the other N−1 test cases may be represented in a 1×N matrix as follows:

$$[ \begin{matrix}{β}_{( Case i , Case 0 )} & … & {β}_{( Case i , Case k )} & … & {β}_{( Case i , Case N - 1 )} ]\end{matrix}$$

The test case plurality correlation degree reflects the test correlation of a test case against the other test cases in the plurality of test cases.

In an example embodiment, the test correlation selection system 105 determines a test case set correlation degree, where the test case set correlation degree is a sum of test case plurality correlation degrees associated with a test case set, where the test case set comprises the plurality of test cases. In this example embodiment, the higher the test case set correlation degree, the greater the correlation between two test cases. The test case set correlation degree is illustrated as follows:

$${β}_{Test Case Set} = {\sum }_{i = 0}^{N - 1} {β}_{case i} = {\sum }_{i = 0}^{N - 1} {\sum }_{j = 0}^{N - 1} {β}_{( Case i , Case j )}$$

Where N=The number of test cases in the plurality of test cases

For a plurality of test cases with N test cases, the test case set correlation degree may be represented in a N×N matrix as follows:

$$[ \begin{matrix}{β}_{( Case 0 , Case 0 )} & … & {β}_{( Case 0 , Case N - 1 )} \\ ⋮ & ⋱ & ⋮ \\ {β}_{( Case N - 1 , Case 0 )} & … & {β}_{( Case N - 1 , Case N - 1 )}\end{matrix} ]$$

The N×N matrix is a symmetrical matrix with all diagonal values equal to 1. The β_{Test Case Set} is the sum of all the elements. The test case set correlation degree may be used to evaluate the test correlation of a plurality of test cases. In this example embodiment, a higher the correlation between test cases indicates more repeated test points.

At 204, the test correlation selection system 105 selects a subset of the plurality of test cases, based on the test case set correlation degree matrix, to execute on a test system to optimize test coverage of the plurality of test cases. When selecting the subset of the plurality of test cases with the goal of coverage all test case points, the smaller the correlation between test cases the better. In an example embodiment, the test correlation selection system 105 selects the subset N from the plurality of test cases M. In this example scenario, all the test cases satisfy the test point requirements. The test correlation selection system 105 calculates the correlation between each test case β_{(Case i,Case j)} to generate the M×M case set matrix. For example, assume the required subset of test cases is 4 test cases from the plurality of 8 test cases {test case 0, test case 1, test case 2, test case 3, test case 4, test case 5, test case 6, and test case 7}. In this example embodiment, the test case set matrix is an 8×8 matrix as illustrated below (with the leftmost column representing test case 0, and the rightmost column representing test case 7):

$${β}_{Test Case Set} = [ \begin{matrix}1 & 0.467 & 0.032 & 0.001 & 0 & 0.012 & 0 & 0.431 \\ 0.467 & 1 & 0.551 & 0.044 & 0.021 & 0.001 & 0 & 0.01 \\ 0.032 & 0.551 & 1 & 0.003 & 0.001 & 0.002 & 0.021 & 0.012 \\ 0.001 & 0.044 & 0.003 & 1 & 0 & 0 & 0.301 & 0 \\ 0 & 0.021 & 0.001 & 0 & 1 & 0.043 & 0.15 & 0 \\ 0.012 & 0.001 & 0.002 & 0 & 0.043 & 1 & 0.003 & 0.01 \\ 0 & 0 & 0.021 & 0.301 & 0.15 & 0.003 & 1 & 0.002 \\ 0.431 & 0.01 & 0.012 & 0 & 0 & 0.01 & 0.002 & 1\end{matrix} ]$$

In an example embodiment, the test correlation selection system 105 calculates the sum of each column in the M×M case set matrix. In this example embodiment, this calculation is determined to be as follows:

$$[ {β}_{Case 0} , ... , {β}_{Case 7} ] = [ 1.943 , \text{} 2.094 , 1.622 , 1.349 , 1.215 , 1.071 , 1.477 , 1.465 ]$$

In an example embodiment, the test correlation selection system 105 determines a minimum sum of matrix elements associated with a column of a test case set correlation degree matrix, and selects a test case associated with the column for inclusion in the subset of the plurality of test cases. In this example embodiment, the minimum column (β_{Case 5}=1.071) is test case 5. Thus, the test correlation selection system 105 selects test case 5 for inclusion in the subset of the plurality of test cases to optimize test coverage.

In an example embodiment, the test correlation selection system 105 replaces the column with zeros in the test case set correlation degree matrix, and replaces a row associated with the selected test case with zeros in the test case set correlation degree matrix. This replacement is illustrated below:

$${β}_{Test Case Set} = [ \begin{matrix}1 & 0.467 & 0.032 & 0.001 & 0 & & 0 & 0.431 \\ 0.467 & 1 & 0.551 & 0.044 & 0.021 & & 0 & 0.01 \\ 0.032 & 0.551 & 1 & 0.003 & 0.001 & & 0.021 & 0.012 \\ 0.001 & 0.044 & 0.003 & 1 & 0 & & 0.301 & 0 \\ 0 & 0.021 & 0.001 & 0 & 1 & & 0.15 & 0 \\ & & & & & & & \\ 0 & 0 & 0.021 & 0.301 & 0.15 & & 1 & 0.002 \\ 0.431 & 0.01 & 0.012 & 0 & 0 & & 0.002 & 1\end{matrix} ]$$

In an example embodiment, the test correlation selection system 105 repeats the steps of determining the minimum sum of matrix elements and selecting the test case after replacing the column with zeros in the test case set correlation degree matrix. For example, the test correlation selection system 105 re-calculates the sum of each column in the test case set correlation degree matrix, and obtains the following values [1.931, 2.093, 1.62, 1.349, 1.172, 0, 1.474, 1.455]. In this example embodiment, the minimum column is β_{Case 4}=1.172. Thus, test case 4 is selected for inclusion the subset of the plurality of test cases. In the test case set correlation degree matrix, the test correlation selection system 105 replaces all the values in column 4 and row 4 with zeros. The test correlation selection system 105 then re-calculates the sum of each column in the test case set correlation degree matrix and obtains the following values [1.931, 2.073, 1.619, 1.301, 0, 0, 1.324, 1.455], where the minimal column case 3=1.301. Thus, test case 3 is selected for inclusion in the subset of the plurality of test cases. The test correlation selection system 105 then replaces the values in column 3 and row 3 with 0. The test correlation selection system 105 then re-calculates the sum of each column in the test case set correlation degree matrix and obtains the following values [1.93, 2.006, 1.616, 0, 0, 0, 1.123, 1.455], where the minimal column β_{Case 6}=1.123. Thus, test case 6 is selected for inclusion in the subset of the plurality of test cases. The test correlation selection system 105 has determined that the subset of the plurality of test cases comprises test case 5, test case 4, test case 3, and test case 6. These selected test cases have the minimum correlation between the test cases to optimize test coverage during testing of a test system 102-N.

In an example embodiment, the test correlation selection system 105 determines that there are at least two columns associated with the minimum sum, meaning there are at least two columns that have the same minimum sum. In this example scenario, the test correlation selection system 105 randomly selects one of the columns for inclusion in the subset of the plurality of test cases.

Accordingly, the particular processing operations and other functionality described in conjunction with the flow diagram of FIG. 2 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to provide a quantitative, algorithm to analyze the correlation between test cases to achieve optimal test efficiency. These and other embodiments can effectively improve test case coverage relative to conventional approaches. For example, embodiments disclosed herein provide a standard quantitative test case selection algorithm. Embodiments disclosed herein provide a multi-dimensional failure-based algorithm for expressing the correlation between test cases. Embodiments disclosed herein express the correlation between test cases in different dimensions such as a module layer, test case layer, and test case set layer, using the failures that occur when the test cases are executed.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

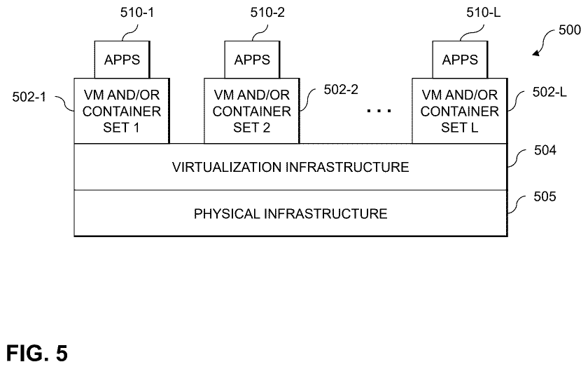

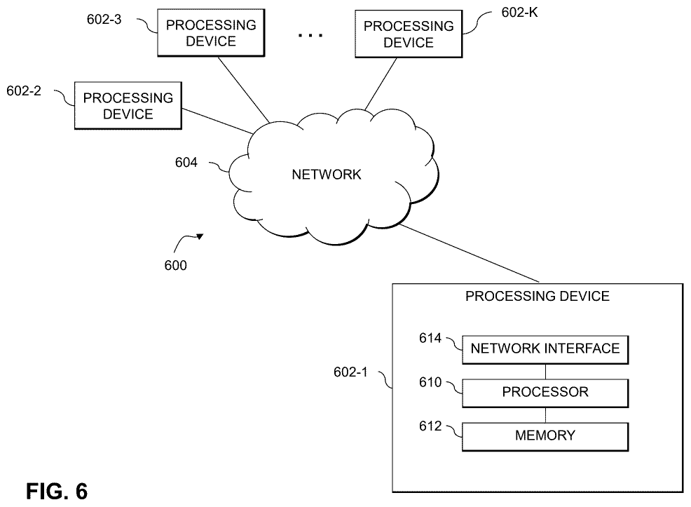

Illustrative embodiments of processing platforms will now be described in greater detail with reference to FIGS. 5 and 6. Although described in the context of the information processing system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, where the hypervisor platform has an associated virtual infrastructure management system. The underlying physical machines comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of the information processing system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a microcontroller, an application-specific integrated circuit (ASIC), a field-programmable gate array (FPGA) or other type of processing circuitry, as well as portions or combinations of such circuitry elements.

The memory 612 comprises random access memory (RAM), read-only memory (ROM) or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
executing a plurality of test cases on a system;
analyzing, by a test correlation selection system, a correlation among the executed test cases by examining a result of the execution of the plurality of test cases to create a test case set correlation degree matrix; and
selecting, by the test correlation selection system, a subset of the plurality of test cases, based on the test case set correlation degree matrix, to execute on a test system to optimize test coverage of the plurality of test cases, wherein the method is implemented by at least one processing device comprising a processor coupled to a memory.

2. The method of claim 1 wherein the result comprises failures that occurred during the execution of the plurality of test cases on the system.

3. The method of claim 1 wherein analyzing, by the test correlation selection system, the correlation among the executed test cases comprises:
creating a test case unique failure list from the result, wherein the test case unique failure list comprises unique failure identifiers associated with a test case, wherein the plurality of test cases comprises the test case.

4. The method of claim 1 wherein analyzing, by the test correlation selection system, the correlation among the executed test cases comprises:
creating a module unique failure list from the result, wherein the module unique failure list comprises unique failure identifiers associated with a test module associated with a test case, wherein a test case comprises one or more test modules.

5. The method of claim 4 further comprising:
creating a test case unique failure list comprising a plurality of unique module unique failure lists associated with a plurality of modules associated with a test case.

6. The method of claim 4 wherein creating the test case unique failure list comprises:
identifying a plurality of failure identifiers associated with the result of the execution of the plurality of test cases, wherein each test case failure that occurs during the execution of the plurality of test cases on the test system is associated with a respective failure identifier of the plurality of failure identifiers.

7. The method of claim 6 further comprising:
for each failure identifier:
determining that the failure identifier does not have an associated parent failure identifier; and
associating the failure identifier with the module unique failure list.

8. The method of claim 6 further comprising:
for each failure identifier:
determining that the failure identifier has an associated parent failure identifier;
determining that the associated parent failure identifier is not associated with the module unique failure list; and
associating the associated parent failure identifier with the module unique failure list.

9. The method of claim 1 wherein analyzing, by the test correlation selection system, the correlation among the executed test cases comprises:
determining a test module correlation degree between at least two test cases associated with a test module, using a module unique failure list.

10. The method of claim 9 further comprising:
representing the test module correlation degree between the at least two test cases for a plurality of test modules, in a matrix format, wherein the plurality of test modules comprises the test module.

11. The method of claim 9 further comprising:
representing the test module correlation degree for a plurality of test cases associated with the plurality of test modules as a test module correlation degree matrix, wherein the test module correlation degree matrix indicates a correlation between at least two test cases at a module level.

12. The method of claim 1 wherein analyzing, by the test correlation selection system, the correlation among the executed test cases comprises:
determining a test case correlation degree between at least two test cases, wherein the test case correlation degree is an average of a plurality of test module correlation degrees for the at least two test cases.

13. The method of claim 12 further comprising:
determining a test case plurality correlation degree, wherein the test case plurality correlation degree is a correlation degree of a test case in the plurality of test cases against the other test cases in the plurality of test cases.

14. The method of claim 13 further comprising:
determining a test case set correlation degree, wherein the test case set correlation degree is a sum of test case plurality correlation degrees associated with a test case set, where the test case set comprises the plurality of test cases.

15. The method of claim 1 wherein selecting, by the test correlation selection system, the subset of the plurality of test cases, based on the correlation comprises:
determining a minimum sum of matrix elements associated with a column of a test case set correlation degree matrix; and
selecting a test case associated with the column for inclusion in the subset of the plurality of test cases.

16. The method of claim 15 further comprising:
replacing the column with zeros in the test case set correlation degree matrix;
replacing a row associated with the selected test case with zeros in the test case set correlation degree matrix.

17. The method of claim 16 further comprising:
repeating the steps of determining the minimum sum of matrix elements and selecting the test case after replacing the column with zeros in the test case set correlation degree matrix.

18. The method of claim 15 further comprising:
determining there are at least two columns associated with the minimum sum; and
randomly selecting one of the at least two columns for inclusion in the subset of the plurality of test cases.

19. A system comprising:
at least one processing device comprising a processor coupled to a memory;
the at least one processing device being configured:
to execute a plurality of test cases on a system;
to analyze, by a test correlation selection system, a correlation among the executed test cases by examining a result of the execution of the plurality of test cases to create a test case set correlation degree matrix; and
to select, by the test correlation selection system, a subset of the plurality of test cases, based on the test case set correlation degree matrix, to execute on a test system to optimize test coverage of the plurality of test cases.

20. A computer program product comprising a non-transitory processor-readable storage medium having stored therein program code of one or more software programs, wherein the program code when executed by at least one processing device causes said at least one processing device:
to execute a plurality of test cases on a system;
to analyze, by a test correlation selection system, a correlation among the executed test cases by examining a result of the execution of the plurality of test cases to create a test case set correlation degree matrix; and
to select, by the test correlation selection system, a subset of the plurality of test cases, based on the test case set correlation degree matrix, to execute on a test system to optimize test coverage of the plurality of test cases.
